(19) United States
(12) Patent Application Publication
(10) Pub. No.: US 2014/0284121 A1
(43) Pub. Date: Sep. 25, 2014

(54) STRUCTURE OF TRAILING ARM FOR VEHICLE

(71) Applicant: Hyundai Motor Company, Seoul (KR)

(72) Inventors: Sangho BAEK, Gwangmyeong-si (KR); Jung Taek LIM, Gwangmyeong-si (KR)

(73) Assignee: Hyundai Motor Company, Seoul (KR)

(21) Appl. No.: 14/058,085

(22) Filed: Oct. 18, 2013

(30) Foreign Application Priority Data
Mar. 25, 2013 (KR) 10-2013-0031657

(51) Int. Cl. B60K 7/00

(52) U.S. Cl. CPC B60K 7/0007
USPC 180/62

(57) ABSTRACT

A structure of a trailing arm for a vehicle according to the exemplary embodiment of the present disclosure may include a trailing arm disposed between a vehicle body and a wheel to absorb torsion generated at the wheel. A drive motor is disposed in an interior space of the trailing arm and serves as a power source of the vehicle. A decelerator is disposed to selectively change a rotation speed of the wheel by receiving a torque of the drive motor.

### CROSS-REFERENCE TO RELATED APPLICATION

This application claims the benefit of priority to Korean Patent Application No. 10-2013-0031657 filed in the Korean Intellectual Property Office on Mar. 25, 2013, the entire contents of which are incorporated herein by reference.

### TECHNICAL FIELD

The present disclosure relates to a structure of a trailing arm for a vehicle, and more particularly, to a structure of a trailing arm for a vehicle in which a drive motor is disposed.

### BACKGROUND

In general, a trailing arm refers to a suspension arm of which a sliding shaft extends forward from an axle. One end of the trailing arm is connected to a frame, and the other end thereof is connected to a suspension system. That is, the trailing arm is vertically installed to absorb torsion, which is generated at the suspension system when a vehicle travels, and to generate restoring force.

Typically, a drive motor, which is a power source of an electric vehicle, is disposed between the trailing arm and a wheel. The wheel is connected to a decelerator which is disposed at each wheel, and the drive motor is engaged with the decelerator by gears.

In the related art, the drive motor is disposed between the trailing arm and the decelerator. According to this disposition of the drive motor of the related art, a spring of the suspension system is disposed far from a rotating axis of the wheel, and therefore, an efficient lever ratio of the spring may be negatively impacted. The disposition of the spring may adversely affect ride comfort. Moreover, space utilization deteriorates in accordance with such a disposition of the drive motor and the spring.

According to the related art, a rotating shaft of the drive motor is disposed parallel to a rotating shaft of the decelerator and engaged with the rotating shaft of the decelerator by gears. This structure may limit a stator and a rotor of the drive motor to be elongated in a rotating shaft direction of the drive motor thereby limiting performance of the drive motor.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a structure of a trailing arm for a vehicle in which a drive motor is disposed in the trailing arm.

In addition, the present disclosure provides a structure of a trailing arm for a vehicle in which a rotating shaft of a drive motor is disposed perpendicular to a rotating shaft of a decelerator.

According to an exemplary embodiment of the present disclosure, a structure of a trailing arm for a vehicle includes a trailing arm disposed between a vehicle body and a wheel and configured to absorb torsion generated at the wheel. A drive motor is disposed in an interior space of the trailing arm and serves as a power source of the vehicle. A decelerator selectively changes a rotation speed of the wheel by receiving torque of the drive motor.

The drive motor may be disposed so that an axial direction of a rotating shaft of the drive motor is identical to a longitudinal direction of the trailing arm.

The rotating shaft of the drive motor and an input shaft of the decelerator may be perpendicularly connected.

The rotating shaft of the drive motor and the input shaft of the decelerator may be connected by bevel gears.

The structure of the trailing arm may further include a suspension system configured to absorb impact and vibration generated when the vehicle travels, in which the suspension system may be disposed near a rotating axis of the wheel.

The trailing arm may have one end connected to the suspension system, and the other end connected to a frame of a vehicle body, and may absorb the torsion generated at the suspension system.

The suspension system may have a spring configured to absorb impact and vibration, and a center of the spring may be disposed on an extension line of a rotation center of the wheel.

A lever ratio of the suspension system may be 1.

### BRIEF DESCRIPTION OF THE DRAWINGS

FIG. 1 is a perspective view illustrating a structure of a trailing arm for a vehicle according to an exemplary embodiment of the present disclosure.

FIG. 2 is a top plan view illustrating the structure of the trailing arm for a vehicle according to an exemplary embodiment of the present disclosure.

### DETAILED DESCRIPTION

An exemplary embodiment of the present disclosure will hereinafter be described in detail with reference to the accompanying drawings.

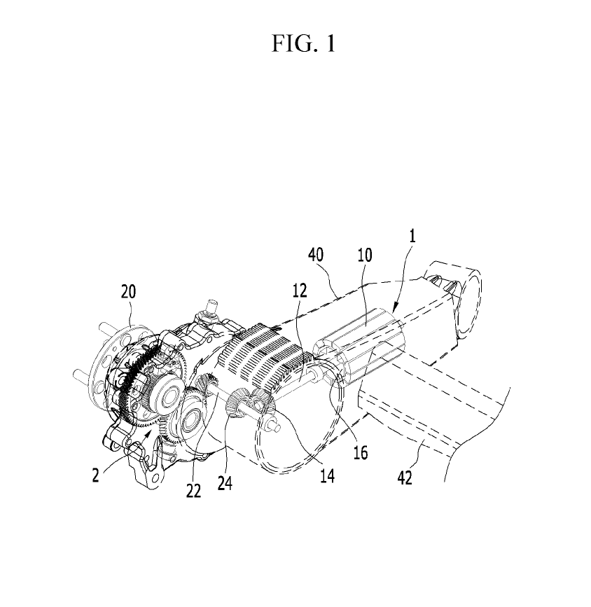

FIG. 1 is a perspective view illustrating a structure of a trailing arm for a vehicle according to an exemplary embodiment of the present disclosure, and

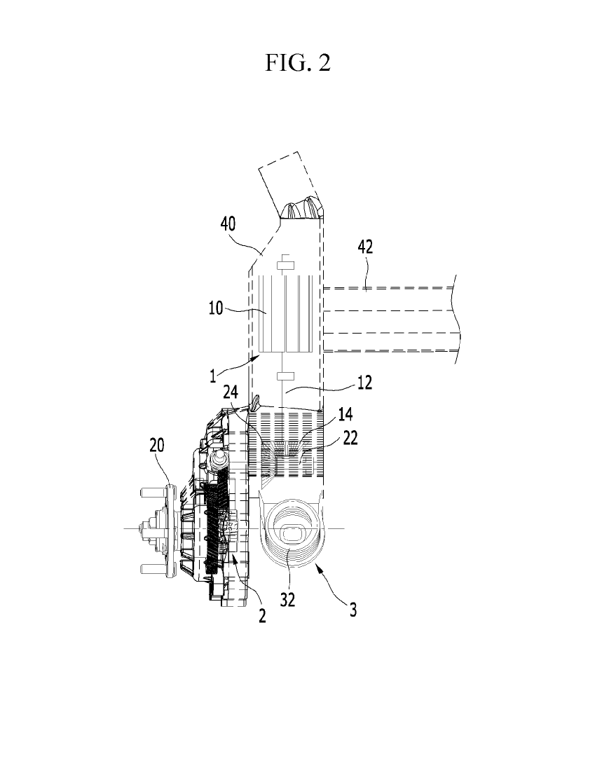

FIG. 2 is a top plan view illustrating the structure of the trailing arm for a vehicle according to an exemplary embodiment of the present disclosure.

As illustrated in FIGS. 1 and 2, a structure of a trailing arm for a vehicle according to an exemplary embodiment of the present disclosure refers to a structure in which a drive motor 1, a decelerator 2, a suspension system 3, and a trailing arm 40 are disposed.

Typically, the drive motor 1 is used as a power source of an electric vehicle. The decelerator 2 is connected to the drive motor 1 and a wheel 20 and variously implements a rotation speed of the wheel 20 by receiving torque of the drive motor 1. The suspension system 3 absorbs impact and vibration transmitted from the road surface to a vehicle body in order to improve ride comfort when the vehicle travels. The trailing arm 40 has one end connected to a frame of the vehicle body and the other end connected to the suspension system 3 so as to absorb torsion, which is generated at the suspension system 3 and the wheel 20 when the vehicle travels, and to generate a restoring force. Moreover, two trailing arms 40, which are disposed at the left and right sides of the vehicle, are connected by a torsion beam 42. Because roles of the drive motor 1, the decelerator 2, the suspension system 3, and the trailing arm 40 are obvious to a person having ordinary skill in the art (hereinafter referred to as a person skilled in the art), a more detailed description will be omitted.

The drive motor 1 according to an exemplary embodiment of the present disclosure is disposed in an interior space of the trailing arm 40. In addition, the drive motor 1 includes a stator 10, a rotor 16, and a rotating shaft 12.

The stator 10 and the rotor 16 convert electric force into torque. That is, the rotor 16 is rotated by electric power applied to the stator 10. In addition, the rotating shaft 12 is connected to the rotor 16 and outputs torque of the rotor 16. Since functions of the stator 10, the rotor 16, and the rotating shaft 12 are obvious to a person skilled in the art, a more detailed description will be omitted.

The drive motor 1, which is provided in the interior space of the trailing arm 40, is disposed so that an axial direction of the rotating shaft 12 is identical to a longitudinal direction of the trailing arm 40.

The decelerator 2, which is connected to the wheel 20, includes an input shaft 22. The input shaft 22 is disposed parallel to a rotating axis of the wheel 20. That is, the input shaft 22 of the decelerator 2 is perpendicular to the rotating shaft 12 of the drive motor 1. The rotating shaft 12 and the input shaft 22 are connected to each other by gears. Thereby, torque of the drive motor 1 is transferred to a transmission through the input shaft 22.

A rotating shaft gear 14 is disposed on one end of the rotating shaft 12, and an input shaft gear 24 is disposed on one end of the input shaft 22. In addition, the rotating shaft gear 14 and the input shaft gear 24 are engaged with each other by gears. Here, the rotating shaft gear 14 and the input shaft gear 24 may be bevel gears that transmit torque perpendicularly. Although the bevel gears are illustrated in FIGS. 1 and 2 as an example of the rotating shaft gear 14 and the input shaft gear 24, the present disclosure is not limited thereto, and other gears may be applied to transmit torque perpendicularly.

The suspension system 3 includes a spring 32. The suspension system 3 connects an axle and the vehicle body and includes the spring 32 configured to reduce impact transmitted from the road surface when the vehicle travels, a shock absorber configured to absorb free vibration of the spring 32, a stabilizer configured to prevent the vehicle from oscillating in left and right directions, etc. In addition, a lever ratio of the suspension system 3 varies in accordance with a disposition of the spring 32 with respect to the wheel 20.

The spring 32 absorbs impact and vibration transmitted from the road surface to the vehicle body. When the spring 32 is disposed near the rotating axis of the wheel 20, efficiency of the spring 32 may be improved. That is, when the spring 32 is disposed near the rotating axis of the wheel 20, the suspension system 3 has an efficient lever ratio. The spring 32 according to an exemplary embodiment of the present disclosure has a center of the spring 32 disposed on an extension line of a rotation center of the wheel 20. Therefore, an ideal lever ratio of the suspension system 3, that is, a lever ratio of 1, may be implemented.

When the spring 32 is disposed so that the lever ratio of the suspension system 3 becomes 1, the entire load, which is transmitted through the center of the wheel 20, may be attenuated by the spring 32. Therefore, a reaction force is prevented from being generated at the trailing arm 40.

The disposition of the spring 32 is possible when the drive motor 1 is disposed in the interior space of the trailing arm 40. The longitudinal direction of the trailing arm 40 and the axial direction of the drive motor 1 are disposed to be identical to each other.

As described above, according to the exemplary embodiment of the present disclosure, as the drive motor 1 is disposed in the trailing arm 40, space utilization may be improved, and the spring 32 of the suspension system may be disposed so as to have an efficient lever ratio. As the drive motor 1 is disposed in the trailing arm 40 so that the rotating shaft 12 of the drive motor 1 is disposed to be perpendicular to the input shaft 22 of the decelerator 2, the stator 10 and the rotor 16 of the drive motor 1 may be elongated in a rotating shaft direction of the drive motor 1, and performance of the drive motor 1 may be improved.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A structure of a trailing arm for a vehicle, comprising:
a trailing arm disposed between a vehicle body and a wheel and configured to absorb torsion generated at the wheel;
a drive motor disposed in an interior space of the trailing arm and configured to serve as a power source of the vehicle; and
a decelerator disposed to selectively change a rotation speed of the wheel by receiving torque of the drive motor.

2. The structure of claim 1, wherein the drive motor is disposed so that an axial direction of a rotating shaft of the drive motor is identical to a longitudinal direction of the trailing arm.

3. The structure of claim 1, wherein a rotating shaft of the drive motor and an input shaft of the decelerator are perpendicularly connected.

4. The structure of claim 3, wherein the rotating shaft of the drive motor and the input shaft of the decelerator are connected by bevel gears.

5. The structure of claim 1, further comprising:
a suspension system configured to absorb impact and vibration generated when the vehicle travels,
wherein the suspension system is disposed near a rotating axis of the wheel.

6. The structure of claim 5, wherein the trailing arm has one end connected to the suspension system and the other end connected to a frame of a vehicle body and the trailing arm absorbs the torsion generated at the suspension system.

7. The structure of claim 5, wherein:
the suspension system has a spring configured to absorb impact and vibration; and
a center of the spring is disposed on an extension line of a rotation center of the wheel.

8. The structure of claim 7, wherein a lever ratio of the suspension system is 1.
